(19) United States
(12) Patent Application Publication
(10) Pub. No.: US 2007/0217722 A1
(43) Pub. Date: Sep. 20, 2007

(54) Bearing assembly with damping elements

(75) Inventor: Heinz-Jurgen Bohmann, Witten (DE)

Correspondence Address: COHEN, PONTANI, LIEBERMAN & PAVANE, 551 FIFTH AVENUE, SUITE 1210, NEW YORK, NY, 10176, US

(73) Assignee: RENK Aktiengessellschaft, Augsburg (DE)

(21) Appl. No.: 11/713,411

(22) Filed: Mar. 2, 2007

(30) Foreign Application Priority Data
Mar. 3, 2006 (DE) 10 2006 009 859.5

(51) Int. Cl. F16C 23/00

(52) U.S. Cl. 384/248

(57) ABSTRACT

A bearing assembly includes a bearing housing which can be fixed directly to a foundation, guide elements which support a rotating shaft, and damping elements which support the guide elements against the housing. The damping elements are preferably located outside the housing, where they are supported by support elements passing through the housing and retained by covers attached to the housing.

### BACKGROUND OF THE INVENTION

1. Field of the Invention

The invention pertains to a bearing assembly including a bearing housing and guide elements which support a rotating shaft.

2. Description of the Related Art

It is generally known that friction bearings or roller bearings can be provided to support rotating shafts in machines or assemblies. These bearings can be used to provide a shaft with radial guidance and/or to absorb axial forces.

To prevent vibrations or the transmission of structure-borne sound, it is known that structure-borne sound-damping elements can be provided between the foundation and the bearing. For this purpose, the bearing housings are set, for example, on rubber blocks or connected to the foundation by way of hydraulic resonance dampers.

The damping behavior of bearings mounted in this way can be changed by replacing the damping elements. Such adjustments therefore require the complicated work of disassembling the entire bearing.

### SUMMARY OF THE INVENTION

An object of the invention is to provide a bearing assembly with structure-borne sound damping and with vibration damping.

This object is achieved by means of damping elements which support the guide elements against the housing.

In an inventive bearing assembly, optimal isolation of structure-borne sound can be achieved by installing elastomeric elements in the force path between the inner parts of the bearing and the bearing housing. The assembly may be provided with support elements extending through the housing, so that the damping elements are actually outside the housing, and retained there by covers fixed to the housing.

The damping behavior of an inventive bearing can be varied over a wide range by the advantageously simple replacement of the elastomeric elements with elements of different Shore hardness values and pretensions. The elements can be replaced without the need to disassemble the entire bearing housing, which is cumbersome and time-consuming. An advantageously wide bandwidth of possible properties can be achieved simply by replacing the damping elements.

A bearing of the inventive design is advantageously easy to install and to remove and is advantageously compact.

Inventive bearings are especially advantageous when used in yachts, ocean-going vessels, and submarines.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The sole FIGUERE shows an axial friction bearing designed in accordance with the invention.

### DETAILED DESCRIPTION OF THE PRESENTLY PREFERRED EMBODIMENTS

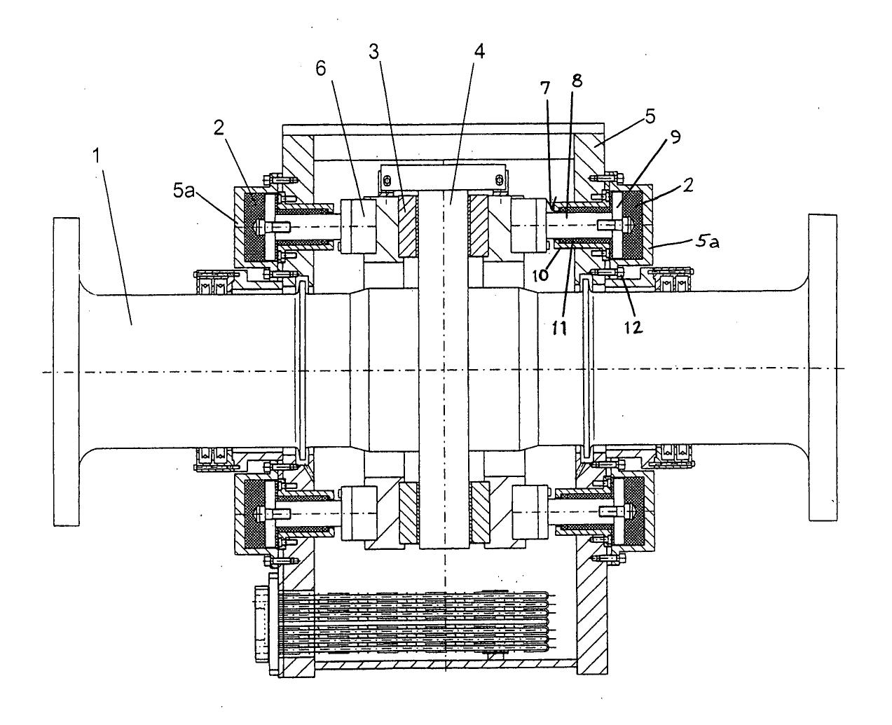

FIG. 1 shows a cross section through a bearing housing 5, which is connected rigidly to a foundation (not shown), that is, tightly joined to it without the intermediate insertion of vibration-damping materials. A shaft 1 with a collar 4, supported on both sides by guide shoes 3, passes through the bearing housing 5. Several guide shoes 3 are preferably provided on each side of the collar 4, arranged in a circle around the shaft 1 and supported with freedom of axial movement in the bearing housing 5 by support elements 7.

Forces which act from left to right on the shaft are transmitted via the collar 4 to the guide shoes 3 mounted on the right next to the collar 4. The guide shoes 3 essentially contact the rotating shaft 1, but for an oil film between the contact surfaces. The oil film is built up in the standard manner, either hydrodynamically or hydrostatically, between the guide shoes 3 and the collar 4 to separate the contact surfaces from each other. Forces which act in the opposite direction on the shaft are transmitted from the guide shoes 3 on the left of the collar 4 to the bearing housing 5.

The guide shoes 3 direct the support force via support elements 7 and damping elements 2 into the bearing housing 5. The damping elements 2 are located on the side of the housing 5 facing away from the collar 4, i.e. outside the bearing housing 5, where they are held in place by retaining covers 5i a. The support elements 7 each include a shaft section 8 which passes through the housing 5, and a support plate 9 located outside the housing, under the respective damping element 2. The housing 5 is fitted with sleeves 10 and elastomeric bushes 11 which receive the shaft sections 8 therethrough so that the support elements 7 can move axially in the housing. The damping elements 2 are preferably made of elastomeric material and can be compressed to various degrees in the bearing housing 5 by adjusting the tension of screws 12 which fix the damping element retaining covers 5a to the housing 5, as a result of which the damping action can be adjusted to the desired value.

The damping elements 2 can also be replaced by elements with a different Shore (Durometer) hardness, which offers another means of adjusting the damping action as desired.

Through the combination of damping elements of a certain Shore hardness with different degrees of pretension, the damping action can be varied over a wide range, and optimal isolation of structure-borne sound between the inner parts of the bearing (guide shoes) and the bearing housing can be obtained for many different types of applications.

The damping elements 2 can be replaced by way of the retaining covers 5a, which are screwed externally onto the bearing housing 5 and can be easily removed. The bearing itself does not have to be disassembled for this purpose.

The inventive bearing damps vibrations in the axial direction and interrupts the transmission of drive noise through the structure.

Inventive bearings are especially advantageous when used to support shafts, especially propeller shafts, of ships such as yachts, ocean-going vessels, or navy ships or submarines.

The invention is not limited to axial friction bearings (thrust bearings). On the contrary, it can also be used for radial friction bearings and in principle also for roller bearings of appropriate design.

The principal advantage of the present invention is that drive vibrations are damped precisely at the place where they are introduced into the bearing. For this purpose, the guide elements of the bearing —the sliding surfaces, the guide shoes, or the raceways of roller bearings—are connected to the bearing housing by way of intermediate layers of vibration-damping material.

Through the intermediate installation of a hydraulic unit 6 with a closed, ring-like circuit, furthermore, hydraulic damping can also be provided.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A bearing assembly comprising:
a bearing housing which can be fixed directly to a foundation;
guide elements which support a rotating shaft; and
damping elements which support the guide elements against the housing.

2. The bearing assembly of claim 1 wherein the damping elements are made of elastomeric material.

3. The bearing assembly of claim 1 wherein the damping elements can be replaced by damping elements having a different Shore hardness.

4. The bearing assembly of claim 1 further comprising means for adjusting the compression of the damping elements.

5. The bearing assembly of claim 1 wherein the damping elements are located outside of the bearing housing, the bearing assembly further comprising covers attached to the housing over respective said damping elements, wherein the damping elements can be replaced by removing said covers.

6. The bearing assembly of claim 1 wherein the guide elements have sliding surfaces which are essentially in contact with the shaft.

7. The bearing assembly of claim 6 wherein the sliding surfaces are positioned to bear axially against a collar on a rotating shaft.

8. The bearing assembly of claim 1 further comprising at least one hydraulic damping unit is located between the means for supporting a rotating shaft and the damping elements.

9. The bearing assembly of claim 1 further comprising support elements between the guide elements and the damping elements, said support elements passing through said housing, said damping elements being located outside of said housing.

10. The bearing assembly of claim 10 further comprising retaining covers which are fixed to said housing and retain said damping elements against said housing.

11. The bearing assembly of claim 11 wherein said retaining covers are fixed to said housing by screws, whereby the damping elements can be compressed to a desired degree by adjusting the tension in said screws.

12. The bearing assembly of claim 10 wherein said support elements each comprise a shaft section which passes through said housing, and a support plate located outside of said housing and under a respective said damping element, said damping elements being sandwiched between said covers and said support plates.

13. The bearing assembly of claim 12 further comprising sleeves fixed in said housing and receiving said shaft sections therethrough.

14. The bearing assembly of claim 13 wherein each said sleeve is provided with an elastomeric bush which contacts a respective said shaft section.
